(19) United States
(12) Patent Application Publication
(10) Pub. No.: US 2024/0335058 A1
(43) Pub. Date: Oct. 10, 2024

(54) Device for preparing a hot or cold drink by infusing a product in water

(71) Applicant: Alban STAMM, STRASBOURG (FR)

(72) Inventor: Alban STAMM, STRASBOURG (FR)

(21) Appl. No.: 18/580,663

(22) PCT Filed: Jul. 19, 2022
(86) PCT No.: PCT/FR2022/051431

§ 371 Date: Jan. 19, 2024

(30) Foreign Application Priority Data
Jul. 22, 2021 (FR) FR21/07917

(51) Int. Cl. A47J 31/057; A47J 31/06; A47J 31/54

(52) U.S. Cl. CPC A47J 31/057; A47J 31/0615; A47J 31/542

(57) ABSTRACT

The present invention relates to a device for preparing a hot or cold beverage, by infusion of a product in water, comprising at least one water supply, heating means for heating the water and an infuser that is able to receive a given volume of water, the infuser comprising at least retaining means for retaining the product to be infused, means for discharging the infusion, two separate volumes, a first volume referred to as the heating volume and a second volume referred to as the retaining and infusion volume in which the retaining means extend, the infuser being able to be driven in movement by means of a motor, wherein the infuser is made up of two shells, a first shell (19) defining the first volume and a second shell (20) defining the second volume, which are open and the openings of which extend one in line with the other.

### TECHNICAL FIELD

The present disclosure concerns a device for preparing a hot or cold beverage, by infusion of a product in water. The disclosure will find numerous applications and more particularly in the field of obtaining tea.

### BACKGROUND

It is well known to prepare tea by heating a volume of water then soaking tea leaves in said hot water. The tea leaves are, after infusion, removed by pouring the water and the tea leaves through a filter, the latter retaining the said leaves.

It is also known to prepare tea by heating water, then pouring the hot water into a cup or the like, then immersing a diffuser bag containing tea leaves in said hot water. The tea leaves then release their aromas, theine, etc. until their concentration is to the convenience of the consumer, the latter then removing the bag from the water to consume the beverage thus obtained.

In order to make the preparation of tea more practical, we have already imagined machines for preparing tea or the like. This is particularly the case for documents EP2937023, EP3415049 and WO2014/006053.

Document EP2937023 describes a fully automatic tea preparation machine, comprising a base assembly and a tea preparation assembly disposed on the base assembly including a water pump for pumping water into the tea preparation assembly and a motor, said tea preparation assembly comprising a tea preparation cavity with an open upper part, a closed lower part and a closed peripheral wall, a tea basket driven by said motor through two clutches cooperating with each other and a drain valve disposed at the bottom of the tea preparation cavity and communicating with the tea preparation cavity.

Document EP3415049 describes an automatic tea preparation machine adapted to automatically prepare tea in a brewing chamber, said machine comprising a pressing device adapted to compress a determined quantity of tea leaves until a tablet is obtained, separately from the tea beverage thus prepared. This document also describes a method for operating a tea machine, in which a tea beverage is prepared with a quantity of tea leaves, and a quantity of water in a brewing chamber, and in which the quantity of tea leaves, once the tea beverage is prepared, is compressed separately to form a tablet.

Document WO2014/006053 describes a tea machine comprising a housing with a front face and a rear face. An infusion chamber and a capsule holder are located on the front of the apparatus. The infusion chamber has a lower rim that defines an opening on its lower face. The infusion chamber may be provided with an opening on its upper face, which is covered by a removable cover, or it may be constructed as a container without an opening on its upper face. The capsule holder is designed to receive one capsule. It is located in a support and preferably has a handle. The capsule holder is preferably approximately circular when viewed from above. The infusion chamber is supported and held in place by a manifold. A water tank, water heating means and a pump are located inside the housing. The lower end of the front face of the housing comprises a tray on which a tumbler is placed when the beverage is dispensed, with a pouring spout placed under the capsule holder.

Although these machines make it possible to prepare tea easily and quickly, they do not provide satisfactory organoleptic features of the tea. To say the least, the organoleptic features of the tea thus obtained are too far away from those of tea prepared in accordance with the almost thousand-year-old Chinese tradition, regardless of the quality of the leaves used.

In order to remedy this drawback, we have already designed a machine for preparing tea in accordance with Chinese tradition. This is the case of European patent EP2051611.

Said European patent EP2051611 describes a device for preparing a hot or cold beverage, by infusion of a product in water, including a water supply, heating means for heating the water and a control unit cooperating with means for determining the temperature to which said volume of water must be heated and means for determining the infusion time of the product in said heated volume of water, and further comprising at least one infuser capable of receiving a determined volume of water, said infuser comprising at least means for retaining the product to be infused and means for discharging the infusion. Said infuser is driven in movement and includes two distinct volumes, a first volume called the heating volume in which the retaining means extend and a second volume called the retaining and infusing volume, the movement of the infuser making it possible to transfer the determined volume of water at least from the first volume to the second volume then to the discharging means.

Although this type of device allows the preparation of a tea in accordance with Chinese tradition and having excellent organoleptic features, it nevertheless has the disadvantage of being expensive to manufacture, more particularly the infuser, the latter preferably having to be made of porcelain. In addition, this type of device also has the disadvantage of being not very ergonomic, particularly for the introduction of tea leaves into the infusing volume which requires several manipulations of the shell defining the infusing volume.

We also know the patent application WO2017042246 which describes a tea machine marketed by the company Vorwerk® under the brand Temial®

This document describes a tea machine, designed for the automatic preparation of infused beverages, with an upwardly open boiling chamber, with a hot water delivery pipe which is designed to introduce hot water through the high in the boiling chamber and with an outlet present in the boiling chamber through which a liquid may be discharged from the boiling chamber, the outlet being designed to be used optionally in a dispensing position or in a disposal position. The liquid, discharged from the boiling chamber through the outlet, is delivered, in the dispensing position, to a point of dispensing infused beverages and is delivered, in the disposal position, to a flow of wastewater.

This type of device has the disadvantage of being bulky, cumbersome and complicated to clean due to its structure. Furthermore, in this type of device, it is not possible to use capsules or pre-dosed tea bags and the tea leaves float on the surface of the hot water so that they do not are infused properly.

### BRIEF SUMMARY

One of the aims of the disclosure is therefore to remedy these disadvantages by proposing a device of simple and inexpensive design, ergonomic and easy to maintain, for the preparation of a hot or cold beverage by infusion, such as tea for example, with great organoleptic quality reproducing the know-how of tea masters. For this purpose, and in accordance with the disclosure, a device is proposed for the preparation of a hot or cold beverage, by infusion of a product in water, comprising at least one water supply, heating means for heating the water and an infuser capable of receiving a determined volume of water, said infuser comprising at least retaining means for retaining the product to be infused, means for discharging the infusion, two distinct volumes, a first volume called heating volume and a second volume called retaining and infusing volume in which the retaining means extend, said infuser being capable of being driven in movement by means of a motor; said device being remarkable in that said infuser consists of two shells, a first shell defining the first volume and a second shell defining the second volume, open and whose openings extend one in line with the other.

Preferably, the peripheral edges of the shells defining the first and second volumes are not in contact and are separated by a determined space.

Said determined space is less than or equal to 5 mm, and preferably less than or equal to 2 mm.

According to one variant, the device comprises a first crown secured to the peripheral edge of the shell defining the first volume, said crown including an axis of rotation cooperating with the motor.

Furthermore, it comprises a second crown secured to the peripheral edge of the shell defining the second volume and capable of cooperating with the first crown to ensure the assembly of the two shells.

Said second crown comprises a grip tab.

In addition, it comprises a seal secured to the first or second crown and ensuring sealing between the two shells.

Furthermore, the discharging means are positioned between the two shells.

Said discharging means consist of a hollow positioned on the peripheral edge of the shell defining the second volume.

According to one variant, said shells have a substantially hemispherical or hemi-ovoid shape.

According to another variant, said shells have a substantially parallelepiped shape.

According to another variant, the shell forming the first so-called heating volume is in the form of a cover.

Furthermore, the shell defining the first volume includes an axis of rotation cooperating with the motor, said axis of rotation including a so-called supply pipe emerging into said first volume and fluidly connected to the heating means.

In addition, the heating means consist of a boiler comprising a thermal resistance, a water supply pipe, a discharge pipe and an atmospheric pressure pipe in which a piston is able to be moved from an open position to a closed position.

According to one variant, the heating means consist of a boiler comprising at least one body open at its upper end, a thermal resistance, a water supply pipe, a discharge pipe and a soft and elastic membrane closing the upper end of the body of the boiler whose lower end is closed.

Advantageously, the heating means comprise a second soft and elastic membrane capping the first membrane.

Incidentally, the heating means comprise, between the first soft and elastic membrane and the second soft and elastic membrane, so-called lubricating and/or insulating means making it possible to avoid an adhesion between the two membranes and to provide a relative sliding between said membranes.

Furthermore, the shell defining the first volume includes at least one blister extending parallel to the plane of the peripheral edge of said shell.

Preferably, the shell defining the first volume has two blisters extending on either side of the sagittal plane of the shell.

Furthermore, the shell defining the second volume has four shoulders extending, in pairs, on either side of the sagittal plane and of the frontal plane of the shell and on which a retaining grid for retaining the product to be infused rests.

In addition, the device includes means for blocking the retaining grid.

Said blocking means consist of a blade or a curved flexible rope, a first end of which is secured to the crown of the shell defining the first volume or secured to the axis of rotation of the shell and the opposite end of which rests on the retaining grid when the shells are assembled.

According to one variant, said blocking means consist of a blade or a curved flexible rope, a first end of which rests on or is secured to the shell defining the first volume, when the shells are assembled, and the opposite end of which is secured to or rests on the retaining grid.

Advantageously, the device comprises a control unit cooperating with means for determining the temperature to which said volume of water must be heated and means for determining the infusion time of the product in said heated volume of water.

### BRIEF DESCRIPTION OF THE DRAWINGS

Other advantages and features will emerge better from the description which follows of several variants, given by way of non-limiting examples, of the device for preparing a hot or cold beverage by infusion of a product in water according to the disclosure, with reference to the appended drawings in which:

FIG. 1 is a perspective view of the device according to the disclosure,

FIG. 2 is an exploded perspective view of the device according to the disclosure represented in FIG. 1,

FIG. 3 is an exploded sagittal sectional view of the device according to the disclosure represented in FIG. 1,

FIG. 4 is a sagittal sectional view of the device according to the disclosure represented in FIG. 1,

FIG. 5 is a sagittal sectional view of the infuser of the device according to the disclosure represented in FIGS. 1 to 4,

FIG. 6 is a front sectional view of the infuser of the device according to the disclosure represented in FIGS. 1 to 4,

FIG. 7 is an exploded perspective view of the boiler of the device according to the disclosure,

FIG. 8 is a sagittal sectional view of the boiler of the device according to the disclosure,

FIG. 9 is a perspective view of one variant of the device according to the disclosure,

FIG. 10 is a sagittal sectional view of the second variant of the device according to the disclosure represented in FIG. 9,

FIG. 11 is a schematic representation of the connected management of the device according to the disclosure.

### DETAILED DESCRIPTION

In the rest of the description of the device for preparing a hot or cold beverage by infusion of a product in water according to the disclosure, the same numerical references designate the same elements. The different views are not necessarily drawn to scale. The device according to the disclosure is particularly intended for the preparation of tea; However, the device can be used for preparing a hot or cold beverage by infusing any product in water without departing from the scope of the disclosure.

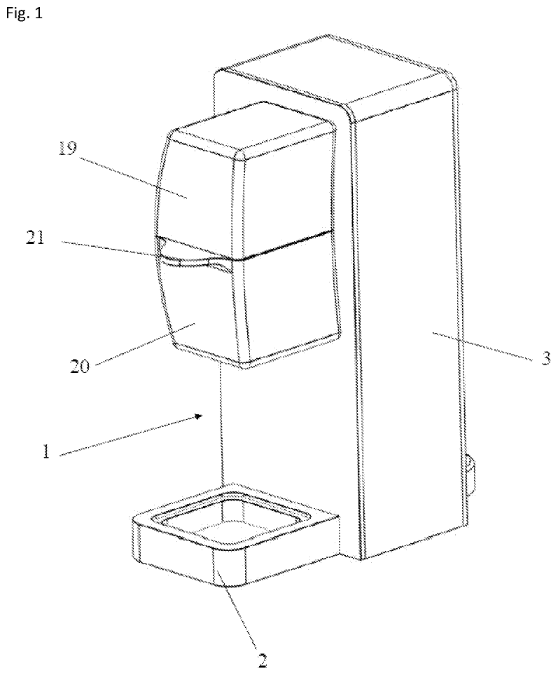

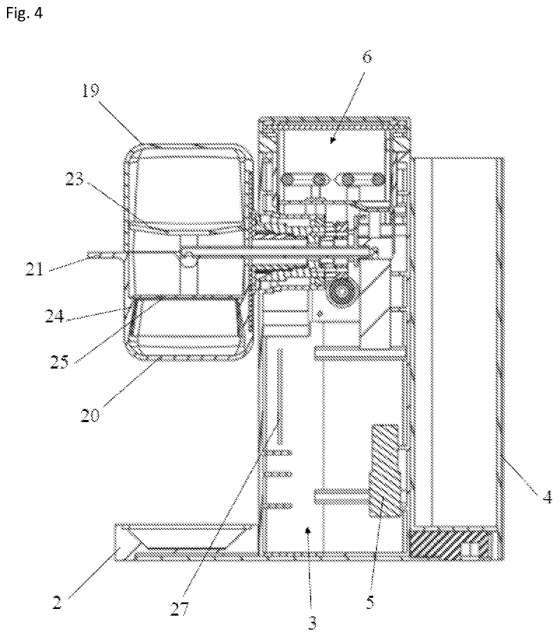

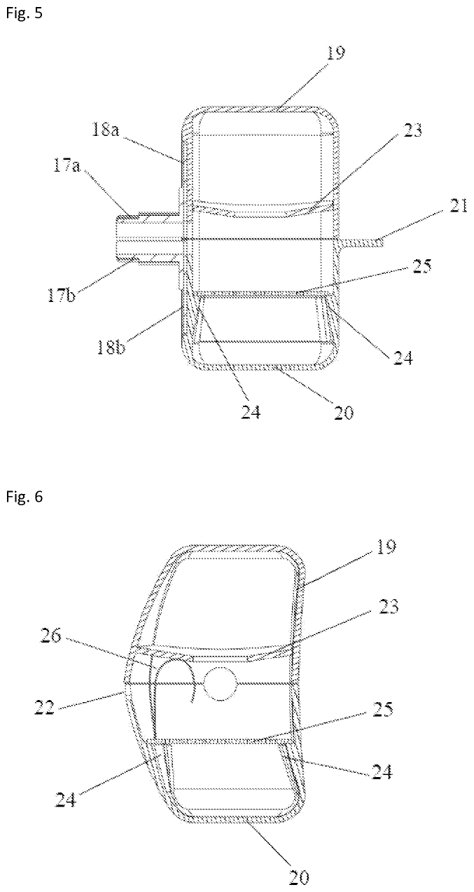

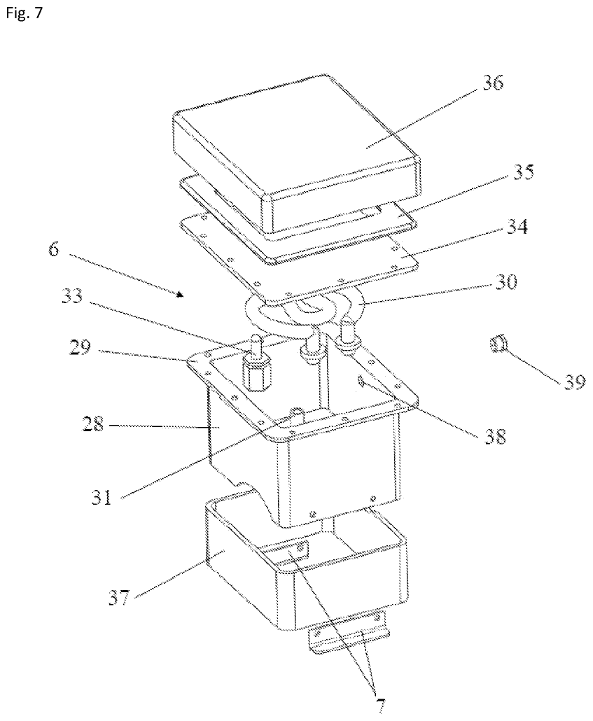

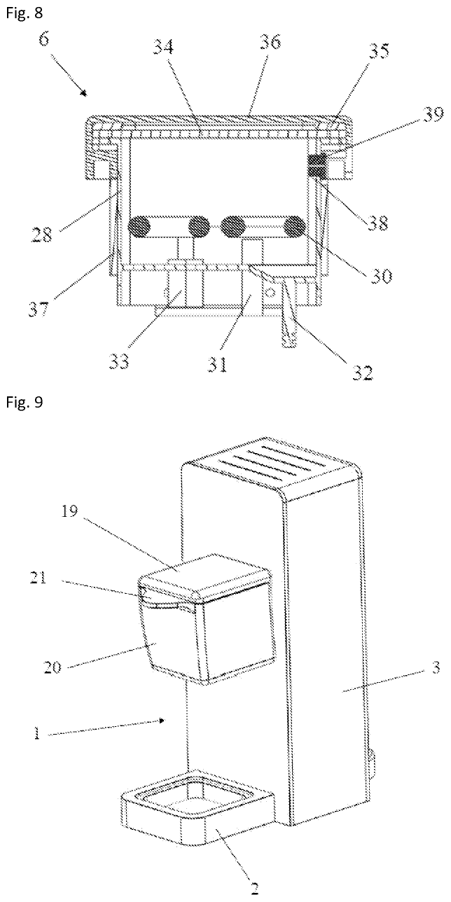

The device according to the disclosure, with reference to FIGS. 1 to 8, consists of a base 1 forming a stand and extending by a hollow support 2 on which is placed a grid, not represented on the figures, forming a support for a cup or any other similar container. Said base 1 also carries a vertical casing 3, of substantially parallelepiped shape, consisting of two parts 3a and 3b.

The device also includes a substantially parallelepiped water tank 4 extending vertically along the rear face of the casing 3. The lower end of said water tank 4 includes a valve connected by a flexible pipe, not represented on the figures, to a pump 5, such as a rotary pump or the like, said pump 5 supplying by means of a soft pipe, not represented on the figures, a boiler 6 extending at the upper end, and inside, of the casing 3, the upper end of the boiler 6 closing the upper end of the casing 3. Said boiler 6 comprises at its lower end lateral tabs 7 capable of sliding in slides 8 formed in the inner walls of the two parts 3a and 3b of the casing 3, near their upper ends.

Furthermore, the device includes an electric motor 9 driving an endless screw 10 cooperating with a toothed wheel 11, the electric motor 9 being secured to a support plate 12. Said toothed wheel 11 is secured to a coupling piece 13 cooperating with a cylindrical axis 14 mounted on two bearings 15 and 16, each bearing 15 and 16 consisting of a ball bearing.

Furthermore, said cylindrical axis 14 interlockingly receives a sleeve consisting of two substantially semi-cylindrical parts 17a, 17b, each of the parts 17a, 17b being secured to a platen 18a and 18b respectively which is secured to a first shell 19 of parallelepiped shape defining a first so-called heating volume and respectively to a second shell 20 of also parallelepiped shape and defining a retaining and infusing volume, the second shell 20 extending below the first shell 19 to the right of the latter. Said shells 19, 20 are preferably obtained in porcelain or terra cotta in order to retain the tannins of tea in particular. However, it goes without saying that the shells 19, 20 may be obtained in any other material compatible with food standards such as glass for example without departing from the scope of the disclosure. It will be noted that the shells 19 and 20 can be respectively obtained in two different materials without departing from the scope of the disclosure. Thus, the shells 19, 20 are open and extend one in line with the other, the dimensions of said shells 19, 20 being substantially equal. In this particular exemplary embodiment, the peripheral edges of the shells 19 and 20 defining the first and second volumes respectively are not in contact and are separated by a space less than or equal to 5 mm, and preferably less than or equal to 2 mm. Furthermore, by construction, said shells 19 and 20 are removable relative to the cylindrical axis 14.

It goes without saying that the peripheral edges of the shells 19 and 20 may or may not be in contact by being separated by a space greater than 2 mm without departing from the scope of the disclosure.

In order to facilitate gripping of the second shell 20, the latter includes a grip tab 21.

In addition, the infuser formed by the two shells 19, 20 comprises means for discharging the infused beverage. Said discharging means are positioned between the two shells 19, 20 and consist of an opening such as a hollow 22, substantially V-shaped or similar, positioned on the shell 20 such as on the peripheral edge of the shell 20 defining the second volume, in the frontal plane of said shell 20.

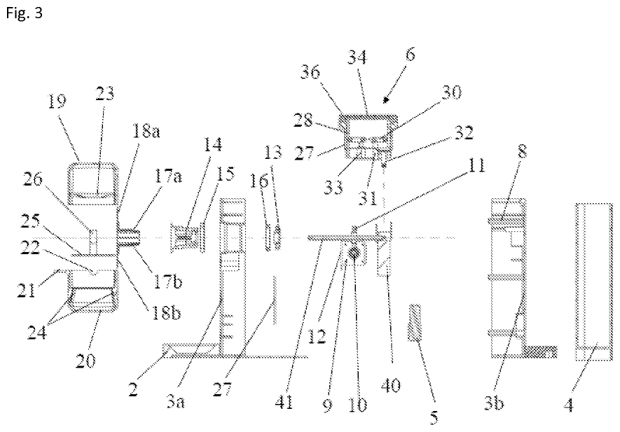

With reference to FIGS. 3 to 6, in order to allow an optimal circulation of water in the infuser, the shell 19 defining the first volume includes at least one blister 23 extending substantially parallel to the plane of the peripheral edge of said shell 19 In this particular exemplary embodiment, said blister 23 consists of a wall inclined towards the shell 20 defining the second volume and provided with a central opening at its lower end.

It goes without saying that the shell 19 defining the first volume can include two or more blisters 23 or inclined walls extending on either side of the sagittal plane of the shell 19, the sagittal plane consisting of the vertical plane containing the axis of rotation of the infuser, without departing from the scope of the disclosure.

In addition, the shell 20 defining the second volume includes at least two shoulders and ideally four shoulders 24 extending, in pairs, on either side of the sagittal plane and of the frontal plane of the shell 20 and on which a retaining grid 25 of the product to be infused rests. Said grid 25 is obtained from metal, has a substantially square or rectangular shape and includes holes and/or slots of dimensions smaller than the dimensions of the product to be infused which is placed under said retaining grid 25. In order to maintain said retaining grid 25 in position, the device also includes means for blocking the retaining grid 25. The latter consist of a flexible curved blade 26, a first end of which rests on the shell 19 defining the first volume or the axis 14, when the shells 19, 20 are assembled, and the opposite end of which is secured to the retaining grid 25.

It is obvious that the flexible blade 26 could be replaced by a flexible rope such as a metal rope for example, and that the first end of the flexible blade 26 can be secured to the axis 14 and/or to the shell 19, instead of resting on the shell 19, and the opposite end of which can rest on the retaining grid 25, without departing from the scope of the disclosure.

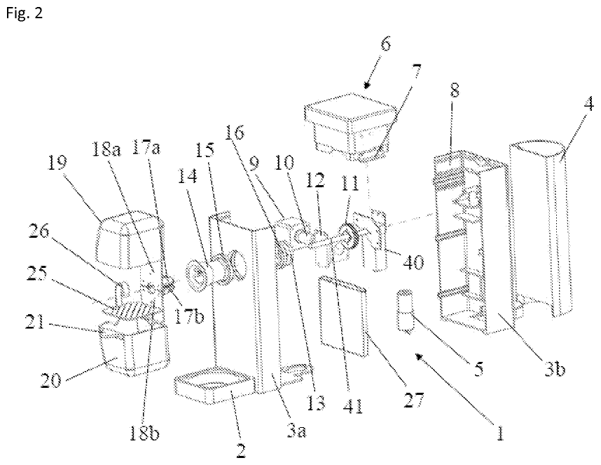

Furthermore, with reference to FIGS. 2 to 4, the device according to the disclosure also includes a control unit 27 connected to a sensor of the water level of the tank and to a sensor of temperature of the boiler 6 as will be detailed below. Said control unit 27 is, moreover, connected to the pump 5, to a solenoid valve 40, to a thermal resistance 30 to heat the water, and to the motor 9 for driving the shells 19, 20 in order to control them as will be detailed below. This control unit 27 comprises on the one hand a memory unit in which information relating to the tea leaves placed in the second shell 20 under the retaining grid 25 are recorded and on the other hand a micro-programmed system such as a microprocessor, or a microcontroller, connected to the memory unit, and in which algorithms constituting means for determining the temperature to which the volume of water must be heated and means for determining the infusion time of the product in said heated volume of water are recorded.

It is quite obvious that the memory unit of the control unit 27 can be externalized, for example, in a smartphone and/or in the “cloud” without departing from the scope of the disclosure.

Incidentally, the device can also include a display screen and buttons for displaying and/or selecting information relating in particular to the tea leaves, the numbers of infusions to be made, the types of infusions to be made, etc.

Furthermore, with reference to FIGS. 2 to 4, 7 and 8, the heating means consist of a boiler 6 comprising at least one parallelepiped body 28 closed at its lower end and open at its upper end, the upper end of said body 28 comprising a peripheral shoulder 29 extending outwards, a thermal resistance 30 extending inside said body 28 and connected to the control unit 27, a water supply pipe 31, a discharge pipe 32, a temperature sensor 33 connected to the control unit 27, a first soft and elastic membrane 34 closing the upper end of the body 28 of the boiler 6 by means of a frame 35 screwed onto the peripheral shoulder 29, and a second soft and elastic membrane 36 capping the shoulder 29, the first membrane 34 and the frame 35. Furthermore, the parallelepiped body 28 is positioned in a jacket 37 also parallelepiped making it possible to isolate the body 28 from the rest of the elements of the device, the lateral legs 7 being fastened to said parallelepiped body in its lower part. Incidentally, the body 28 comprises a hole 38 receiving a safety valve 39 in the event of overpressure in the boiler. Thus, when water is introduced into the body 28 of the boiler 6 by means of the pump, the solenoid valve 40 being in the closed position, the first membrane 34 deforms and maintains the water in the boiler at a pressure greater than atmospheric pressure, the second membrane 36 also deforming under the mechanical action of the first membrane 34. Thus, the water is heated more quickly and the membrane 34 continues to deform when the water is heated to reach its maximum deformation. The water then being heated and under maximum pressure, it quickly discharges from the boiler 6 through the discharge pipe 32 fluidly connected to a solenoid valve 40 the outlet of which is fluidly connected to a rigid pipe 41 passing through the axis of the toothed wheel 11 and the cylindrical axis 14, emerging between the two shells 19, 20 of the infuser, said solenoid valve 40 being connected to the control unit 27. The discharge hole positioned at the free end of the rigid pipe 41 is oriented downwards, towards the interior of the shell 19 or of the shell 20, depending on the position of the infuser 19, 20. It will be noted that, incidentally, the rigid pipe 41 provides a guidance of the part 17b of the sleeve in the cylindrical axis 14 during the placing of the shell 20 under the shell 19.

Advantageously, the heating means can comprise, between the first soft and elastic membrane 34 and the second soft and elastic membrane 36, so-called lubricating and/or insulating means making it possible to avoid an adhesion between the two membranes 34 and 36 and to provide a relative sliding between said membranes 34 and 36. These lubricating and/or insulating means, not represented on the figures, can consist of a Teflon® film or a film of talc or grease or any other similar means well known to those skilled in the art.

According to one variant, not represented on the figures, the infuser consisting of the two shells 19 and 20 can comprise a first crown secured to the peripheral edge of the shell 19 defining the first volume, said crown including an axis of rotation cooperating with the motor, and a second crown secured to the peripheral edge of the shell 20 defining the second volume and capable of cooperating with the first crown to ensure the assembly of the two shells 19 and 20. Furthermore, the second crown comprises a grip tab. Incidentally, the infuser can comprise a seal secured to the first or second crown in order to ensure sealing between the two shells 19 and 20.

We will now explain operation of the device.

Water being previously introduced into the water tank 4 and tea leaves being placed in the second shell 20 under the grid 25, the shell 20 is interlockingly placed on the axis 14 so that the flexible blade 26 blocks the grid 25, then the user selects on the interface, the nature of the leaves introduced (green, black, white, etc. tea), the number of cups (1 cup by default, ½ teapot=2 cups and 1 teapot=4 cups). The control unit 27 then determines at least the temperature and the infusion time.

It should be noted that the user will also be able to select himself the temperature and the duration of infusion according to personal taste by pressing the buttons of the interface.

The control unit 27 then actuates the solenoid valve 40 to put it in the closed position as well as the pump 5 to bring between 150 ml and 200 ml of water into the boiler 6 then controls the thermal resistance 30 to heat the water up to the set temperature determined by said control unit 27.

The infuser is driven in rotation about its axis 14 so that the second shell 20 containing the tea leaves extends above the first shell 19 then the water previously heated in the boiler 6, to the set temperature determined by the control unit 27, is quickly introduced into the first shell 19 through the pipe 41 passing through the axis 14 by actuating the solenoid valve 40 in the open position. The hot water is then not in contact with the tea leaves.

The infuser 19, 20 is then driven in rotation about its axis 14, following a rotation of 180°, in such a way that the hot water, guided by the blister 23, is poured into the second shell 20 containing the tea leaves. Note that the rotation of the infuser 19, 20 and the pouring of the hot water provides an aeration of the water and an agitation favoring a homogeneous mixing of the tea leaves in the water. In addition, the infuser can undergo an alternating rotations of small amplitudes, preferably providing a pendulum movement to the infuser, during the duration of the infusion, thus promoting the creation of a perfectly homogeneous mixture.

When the duration of the infusion is over, the infuser is once again driven in rotation about its axis 14, following a rotation of −90°, to discharge the infusion through the discharge hole 22 which is then located at the lowest point of the infuser 19, 20 and to the right of the cup, or any other container, placed on the grid of the support 2. The tea leaves remain in the shell 20, retained by the retaining grid 25 resting on the four shoulders 24.

It goes without saying that the water tank may be replaced by a continuous water supply by the tap water network for example, the level sensor then being replaced by a flow meter for example.

Furthermore, it should be noted that the tea leaves can be packaged in a bag, said bag being placed under the retaining grid 25.

In addition, the device may comprise means for reading a code identifying the quantity and/or the nature of the tea leaves placed in the second shell 20, said reading means being connected to the control unit 27. The identification code may consist of any identification code well known to those skilled in the art such as a bar code, an electronic chip, a magnetic or optical code, a relief or hollow print for example, the reading means consisting of an optical, magnetic, electronic, mechanical or similar reader.

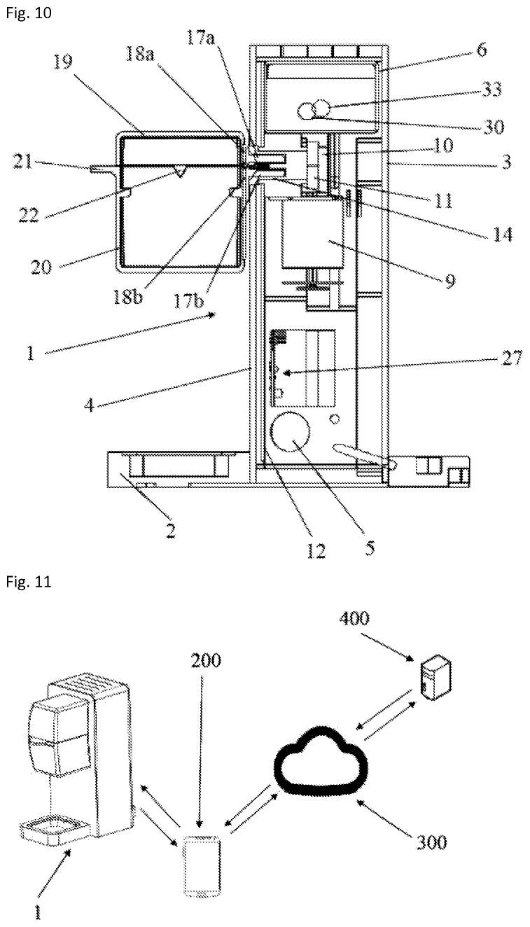

According to one variant of the device according to the disclosure, with reference to FIGS. 9 and 10, the device according to the disclosure is constituted in the same manner as previously of a base 1 forming a stand and extending by a hollow support 2 on which is placed a grid forming a support for a cup or any other similar container. Said base 1 also carries a vertical casing 3, of substantially parallelepiped shape.

The device also includes a substantially parallelepiped water tank, not represented on the figures, extending vertically along the rear face of the casing 3. The lower end of said water tank includes a valve connected by a flexible pipe, not represented on the figures, to a rotary pump 5, said pump 5 supplying by means of a soft pipe, not represented on the figures, a boiler 6 extending at the upper end, and inside, of the casing 3. Said boiler 6 is secured to said casing 3 and includes, in the usual manner, a temperature sensor 33 and heating means 30 such as a thermoresistance for example. Said boiler 6 is identical to that described in the previous variant, the water quickly discharging from the boiler 6 through a discharge pipe fluidly connected to a solenoid valve the outlet of which is fluidly connected to a rigid pipe passing through the axis of the toothed wheel and the cylindrical axis, emerging between the two shells 19, 20 of the infuser, the discharge pipe, the solenoid valve and the rigid pipe not being represented on FIGS. 9 and 10.

Furthermore, the device includes an electric motor 9 driving an endless screw 10 cooperating with a toothed wheel 11, the electric motor 9 being secured to a support plate 12. Said toothed wheel 11 is secured to a cylindrical axis 14 mounted on two bearings, not represented on the figures, each bearing consisting of a ball bearing.

Furthermore, said cylindrical axis 14 interlockingly receives a sleeve consisting of two substantially semi-cylindrical parts 17a, 17b, each of the parts 17a, 17b being secured to a platen 18a and 18b respectively which is secured to a first shell 19 of parallelepiped shape and respectively to a second shell 20 of also parallelepiped shape and defining a retaining and infusing volume, the second shell 20 extending below the first shell 19 to the right of the latter. Thus, the shells 19, 20 are open and extend one in line with the other, the dimensions of the openings of said shells 19, 20 being substantially equal. In this particular exemplary embodiment, the peripheral edges of the shells 19 and 20 defining the first and second volumes respectively are not in contact and are separated by a space less than or equal to 5 millimeters, and preferably less than or equal to 2 millimeters.

In order to facilitate the gripping of the second shell 20, the latter includes a grip tab 21.

In addition, the infuser formed by the two shells 19, 20 comprises, in the same manner as above, means for discharging the infused beverage. Said discharging means are positioned between the two shells 19, 20 and consist of a hollow 22 positioned on the peripheral edge of the shell 20 defining the second volume, in the frontal plane of said shell 20.

Said infuser 19, 20 differs from that described previously by the fact that the first shell 19 of parallelepiped shape defining the first so-called heating volume is flattened and is in the form of a parallelepiped cover. In addition, the parallelepiped shell 19 defining the first volume is secured to an axis of rotation cooperating with the motor 9, said axis of rotation including a so-called supply pipe fluidly connected to the heating means and emerging directly into the second volume formed by the shell 20. Incidentally, with reference to FIG. 11, the device can advantageously be controlled by means of a smartphone 200 capable of communicating with the control unit 27 by a Wi-Fi or Bluetooth link for example, said smartphone 200 including a dedicated application. Said application will advantageously be able to allow the ordering of tea “capsules”, or loose tea depending on the consumption of the user through an internet connection 300 on one or more websites (merchant sites) hosted on a web server 400.

Furthermore, it goes without saying that said shells 19 and 20 forming the infuser can have substantially hemispherical or hemi-ovoid shapes or any other shapes without departing from the scope of the disclosure.

In addition, it is obvious that the boiler 6 can be used for coffee machines or the like without departing from the scope of the disclosure.

Finally, it is quite obvious that the examples which have just been given are only particular illustrations in no way limiting as to the fields of application of the disclosure.

1. A device for preparing a hot or cold beverage, by infusion of a product in water, comprising
at least one water supply,
heating means for heating the water and
an infuser capable of receiving a determined volume of water,
said infuser comprising at least retaining means for retaining the product to be infused, means for discharging the infusion, two distinct volumes, a first volume called heating volume and a second volume called retaining and infusing volume in which the retaining means extend,
said infuser being able to be driven in movement by means of a motor,
wherein said infuser comprises two shells, a first shell-defining the first volume and a second shell defining the second volume, open and whose openings extend one in line with the other.

2. The device according to claim 1 wherein the peripheral edges of the shells defining the first and second volumes are not in contact and are separated by a determined space.

3. The device according to claim 2 wherein said determined space is less than or equal to 5 mm, and preferably less than or equal to 2 mm.

4. The device according to any one of claims 1 to 3 wherein the discharging means are positioned between the two shells.

5. The device according to claim 4 wherein said discharging means comprises a hollow positioned on the peripheral edge of the shell defining the second volume.

6. The device according to claim 1 wherein said shells have a substantially parallelepiped shape.

7. The device according to claim 6 wherein the shell forming the first so-called heating volume is in the form of a cover.

8. The device according to claim 1 wherein the heating means comprises a boiler comprising at least one body open at its upper end, a thermal resistance, a water supply pipe, a discharge pipe and a soft and elastic membrane closing the upper end of the body of the boiler whose lower end is closed.

9. The device according to claim 8 wherein the heating means comprise a second soft and elastic membrane capping the first membrane.

10. The device according to claim 9 wherein the heating means comprise, between the first soft and elastic membrane and the second soft and elastic membrane, so-called lubricating and/or insulating means allowing to avoid an adhesion between the two membranes and to provide a relative sliding between said membranes.

11. The device according to claim 1 characterized in wherein the shell defining the first volume includes at least one blister or a wall inclined towards the shell defining the second volume and provided with a central opening at its lower end.

12. The device according to claim 1 wherein the shell defining the second volume includes four shoulders extending, in pairs, on either side of the sagittal plane and of the frontal plane of the shell and on which a retaining grid for retaining the product to be infused rests.

13. The device according to claim 12 wherein it includes means for blocking the retaining grid.

14. The device according to claim 13 wherein said blocking means consist of a blade or a curved flexible rope, a first end of which is secured to or rests on the shell defining the first volume, when the shells are assembled, and the opposite end of which rests on or is secured to the retaining grid.
